(19) United States
(12) Patent Application Publication
(10) Pub. No.: US 2017/0152704 A1
(43) Pub. Date: Jun. 1, 2017

(54) WINDOW HAVING A RAINWATER GUIDE DEVICE ATTACHED THERETO

(71) Applicant: Hyun Jin CHAE, Jeju-si (KR)

(72) Inventor: Hyun Jin CHAE, Jeju-si (KR)

(21) Appl. No.: 15/194,897

(22) Filed: Jun. 28, 2016

(30) Foreign Application Priority Data
Nov. 30, 2015 (KR) 20-2015-0007810

(51) Int. Cl. E06B 7/14

(52) U.S. Cl. CPC E06B 7/14

(57) ABSTRACT

A rainwater guide device is coupled to an outer side of the rail portion to be adjacent to the rainwater drainage hole, wherein the rainwater guide device includes a rainwater receiving portion defined at one closed side end thereof to receive the rainwater from the drainage hole and having an open top, and a rainwater outlet defined at the other open side end thereof, wherein the bottom plate includes a tilted plate tilted downwards from the rainwater receiving portion to the rainwater outlet in a longitudinal direction thereof, and two rainwater guide plates, each guide plate having a first side coupled to the tilted plate and a second side coupled to a corresponding longitudinal side plate, wherein each of the rainwater guide plates is tilted downwardly from the second side to the first side.

### CROSS-REFERENCE TO RELATED APPLICATION

This application claims the benefit of Korea utility model application No. 20-2015-0007810 filed on Nov. 30, 2015, the entire content of which is incorporated herein by reference for all purposes as if fully set forth herein.

### BACKGROUND

Field of the Present Disclosure

The present disclosure relates to a window frame for a building, and, more particularly, to a widow having a rainwater guide device attached thereto for preventing the rainwater falling from the window from damaging or polluting the wall of the building.

Discussion of the Related Art

Typically, the building has a window provided at the wall thereof.

Korea utility model application publication No. 20-1996-002027 as published on Jan. 19, 1996.01.19 discloses a window frame. This document relates to the corner joint device for the window frame, and as to the core connector for the window frame in which the horizontal and perpendicular frame let project and shape the respective inserted horizontal and vertical core, the flowing drain gutter of the rainwater is formed in the corner joint device main body and it prevents in addition the drainage operation including the rainwater etc. is smoothly made by inducing in order to bind separably the closing plate which it induces so that the flow of the rainwater is circulated in the drain gutter and be circulated with the closing plate in which the flow including the rainwater etc. is combined selectively and flow the drain time being reduced and the rainwater from being flowed in into the indoor and it is clean and it is hygienic and the invasion including wind etc. is blocked and flows with especially, the extrinsic department the insulation effect can be improved.

However, in this document, the rainwater may flow through the rainwater drainage hole formed in the window frame and along and on the wall of the building, thereby to damage or pollute the wall of the building, leading to a spot on the wall thereof. This may lead to a poor esthetic view.

### SUMMARY

From considerations of the above situations, the present disclosure provides a widow having a rainwater guide device attached thereto for preventing the rainwater falling from the window from damaging or polluting the wall of the building.

In an aspect of the present disclosure, there is provided a window having a rainwater guide device attached thereto, wherein the widow includes a window frame having a rail portion having a rainwater drainage hole formed in a side face thereof, wherein the rainwater guide device is coupled to an outer side of the rail portion to be adjacent to the rainwater drainage hole, wherein the rainwater guide device includes a horizontally elongate bottom plate, and two parallel facing-away longitudinal plates and a single transverse plate, all of the side plates being coupled to the bottom plate, wherein the rainwater guide device includes a rainwater receiving portion defined at one closed side end thereof to receive the rainwater from the drainage hole and having an open top, and a rainwater outlet defined at the other open side end thereof, through which the rainwater may flow out of the device, wherein the bottom plate includes a tilted plate tilted downwards from the rainwater receiving portion to the rainwater outlet in a longitudinal direction thereof, and two rainwater guide plates, each guide plate having a first side coupled to the tilted plate and a second side coupled to a corresponding longitudinal side plate, wherein each of the rainwater guide plates is tilted downwardly from the second side to the first side.

In one embodiment, the longitudinal side plate facing the window frame has a downward-tilted face defined thereon adjacent to and directly under the drainage hole.

In one embodiment, the device has an extended rainwater guide portion protruding perpendicularly to the length direction of the rainwater guide device at the rainwater outlet side.

In one embodiment, the device has a plurality of fixing pins protruding from the side face of the side longitudinal plate facing the window frame, wherein the window frame rail portion has a plurality of fixing grooves formed in a side face thereof corresponding to the fixing pins, wherein the fixing pins are pressure-fitted into the fixing grooves respectively.

In one embodiment, each of the fixing pins includes as a rod structure having a stopper formed at a free end thereof, wherein the rod structure and/or stopper has an inner cut defined horizontally therein to define a gap, wherein the gap is narrow when the pin is inserted into the groove, and the stopper acts to prevent the fixing pin from escaping from the fixing groove.

### BRIEF DESCRIPTIONS OF THE DRAWINGS

The accompanying drawings included to provide a further understanding of the present disclosure illustrate embodiments of the present disclosure.

FIG. 1 shows a perspective view of a window frame in accordance with the present disclosure.

FIG. 2 shows a perspective view of a rainwater guide device attached to a window frame in accordance with one embodiment of the present disclosure.

FIG. 3 shows a perspective view of a rainwater guide device in accordance with one embodiment of the present disclosure.

FIG. 4 shows a side view of a rainwater guide device in accordance with one embodiment of the present disclosure.

FIG. 5 shows a cross sectional view of a rainwater guide device as taken in a line A-A in FIG. 3.

FIG. 6 shows a perspective view of a rainwater guide device attached to a window frame in accordance with another embodiment of the present disclosure.

FIG. 7 shows a perspective view of a rainwater guide device attached to a window frame in accordance with another embodiment of the present disclosure.

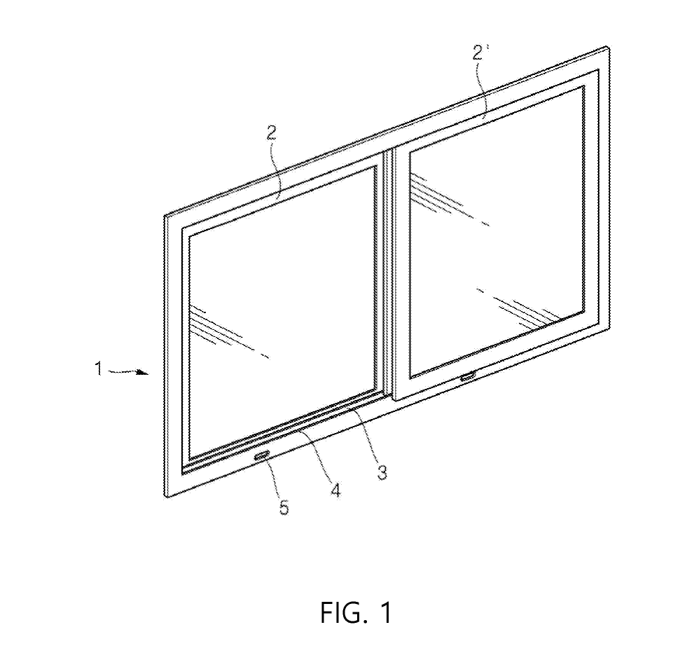

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,”“below,”“lower,”“under,” “above,” “upper,” and the like, may be used herein for ease of explanation to describe one element or feature's relationship to another elements or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

### First Embodiment

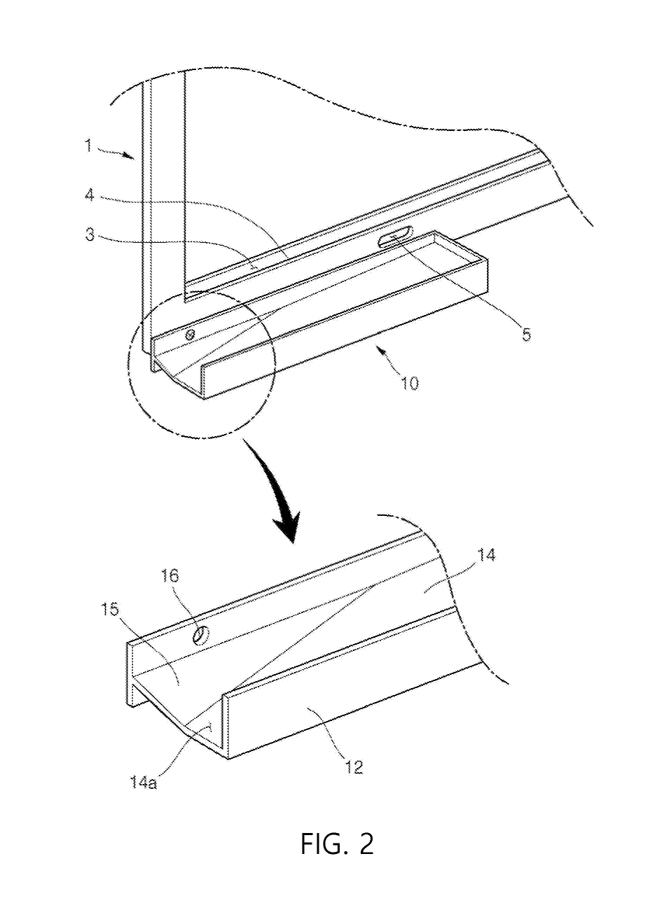

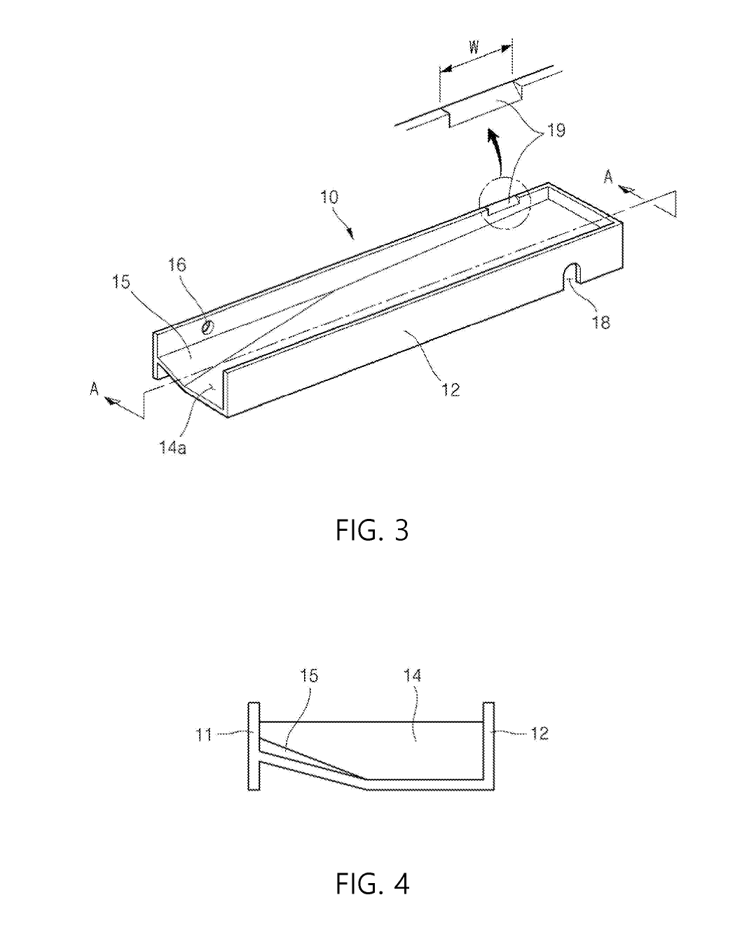

Hereinafter, a first embodiment of the present disclosure will be described in details with reference to attached drawings, specifically, FIG. 2 to FIG. 5.

FIG. 2 to FIG. 5 show a present rainwater guide device 10 for a window frame. The rainwater guide device 10 may be coupled to an outer side of a rail 4 of the widow frame 1 in which a drainage hole 5 is formed.

The rainwater guide device 10 may include a bottom plate 14,15 and side plates 11,12,13 coupled to the bottom plate. The rainwater guide device 10 may be horizontally elongate. The side plates 11,12,13 may include two parallel facing-away longitudinal plates 11,12 and a single transverse plate 13. The rainwater guide device 10 may be formed integrally by an injection molding process. The rainwater guide device 10 may have a color similar to or different from that of the window frame 1. The rainwater guide device 10 may be horizontally oriented to match well with the window frame 1 for a view.

The rainwater guide device 10 may have a rainwater receiving portion defined at one closed end thereof to receive the rainwater from the drainage hole 5 of the window frame 1. The rainwater receiving portion has an open top. The rainwater guide device 10 may have a rainwater outlet 14a defined at the other open end thereof, through which the rainwater may flow out of the device 10. The rainwater receiving portion of the rainwater guide device 10 may be positioned directly under the drainage hole 5 of the window frame 1. The other open end of the rainwater guide device 10 may be positioned adjacent to a free side end of the window frame 1. Thus, the rainwater may run through the drainage hole 5 of the window frame 1 to the rainwater receiving portion of the rainwater guide device 10 and then flow along the longitudinal direction to the rainwater outlet 14a through which the rainwater falls onto the ground.

The falling point of the rainwater may set to correspond to the free side end of the window frame 1. This may lead to a good esthetic view.

In this present disclosure, the bottom plate 14,15 may include a tilted plate 14 tilted downwards from the rainwater receiving portion of the rainwater guide device 10 to the rainwater outlet 14a in a longitudinal direction thereof. Further, the bottom plate 14,15 may include two rainwater guide plates 15, each having a first side coupled to the tilted plate 14 and the second side coupled to each corresponding side plate 11 or 12. The first side and second side of the rainwater guide plate 15 may encounter at one point. Each of the rainwater guide plates 15 may be tilted downwardly and inwardly. Both the rainwater guide plates 15 may partially sandwich the tilted plate 14 therebetween. The tilted plate 14 and rainwater guide plates 15 may be formed integrally by bending the bottom plate.

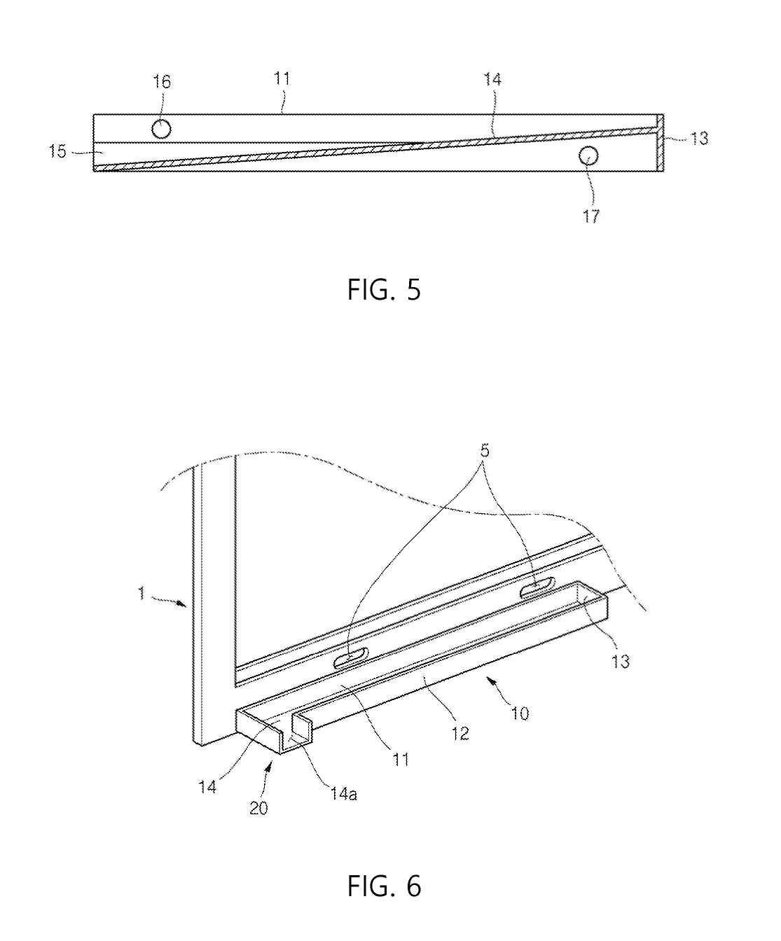

The rainwater guide device 10 may be adhered to the window frame 1 via an adhesive. The present disclosure is not limited thereto. The rainwater guide device 10 may be fastened to the window frame 1 via a screwing manner. For this, the side plates 11 facing the window frame 1 may have bolt insertion holes 16,17 at both horizontal ends thereof as shown in FIG. 5. Bolts to be inserted in the bolt insertion holes 16,17 may be anti-corrosive. In order for a bolt driver to rotate the bolt to reach the bolt insertion holes 16,17, the other side plate 12 facing away the plate 11 may have corresponding driver through holes 18 to the bolt insertion holes 16,17.

In another example of the present disclosure, the side plate 11 facing the window frame 1 may have a downward-tilted face 19 defined thereon adjacent to the drainage hole 5 of the widow frame 1. Thus, the rainwater from the drainage hole 5 may not splash directly onto the bottom plate but may flow along and on the downward-tilted face 19 onto the bottom plate. Otherwise, when the downward-tilted face 19 is not formed, the rainwater from the drainage hole 5 may splash directly onto the bottom plate, and thus, the splashed rainwater on the bottom plate may bounce out of the rainwater guide device 10 onto the wall of the building to pollute the wall. The downward-tilted face 19 may have a width W larger than that of the drainage hole 5.

The rainwater guide device 10 may a horizontal length configured to correspond to a position of the drainage hole 5 along the length of the widow frame 1. The present disclosure is not limited thereto. A plurality of rainwater guide devices 10 may be arranged in series horizontally.

The rainwater guide device 10 may have a top cover (not shown) to cover the open top thereof. The top cover may have one side end adhered to the outer face of the window frame 1 and the other side end coupled to the other side plate 12. The top cover may be tilted downwardly toward the other side plate 12.

### Second Embodiment

Hereinafter, a second embodiment of the present disclosure will be described in details with reference to attached drawing, specifically, FIG. 6.

FIG. 6 shows a present rainwater guide device 10 for a window frame. The rainwater guide device 10 may be coupled to an outer side of a rail 4 of the widow frame 1 in which a plurality of, for example, two drainage holes 5 are formed. In this connection, the length of the rainwater guide device 10 may be larger.

The second embodiment of the rainwater guide device 10 may be substantially the same as the rainwater guide device 10 of the first embodiment except that an extended rainwater guide portion 20 may protrude perpendicularly to the length direction of the rainwater guide device 10 at the rainwater outlet 14a side. This configuration may be suitable for a situation where the wall of the building protrudes beyond the window frame. In this case, the extended rainwater guide portion 20 may prevent the rainwater falling from the rainwater guide device 10 from contacting the wall of the building.

### Third Embodiment

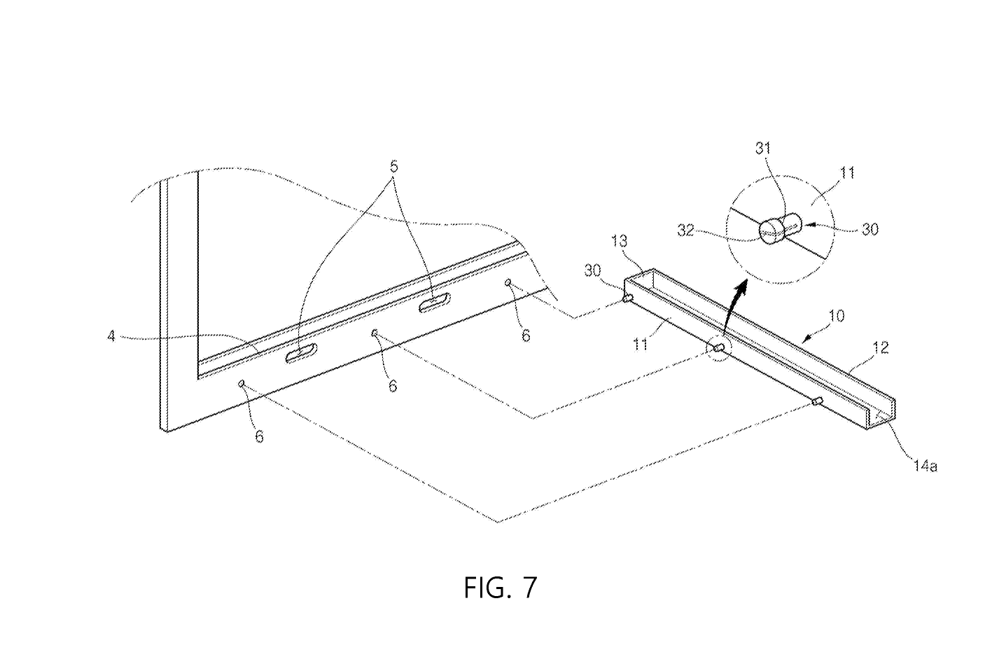

Hereinafter, a third embodiment of the present disclosure will be described in details with reference to attached drawing, specifically, FIG. 7.

FIG. 7 shows a present rainwater guide device 10 for a window frame. The rainwater guide device 10 may be coupled to an outer side of a rail 4 of the widow frame 1 in which a plurality of, for example, two drainage holes 5 are formed. In this connection, the length of the rainwater guide device 10 may be larger.

The third embodiment of the rainwater guide device 10 may be substantially the same as the rainwater guide device 10 of the first embodiment except that a plurality of fixing pins 30 protrudes from the side face of the side plate 11 facing the window frame.

In this connection, the window frame rail portion 4 may have a plurality of fixing grooves 6 formed in a side face thereof corresponding to the fixing pins 30. The fixing pins 30 may be pressure-fitted into the fixing grooves 6 respectively. This may allow the rainwater guide device 10 to be installed onto the window frame more conveniently. Each of the fixing pins 30 may be embodied as a rod having a stopper 31 formed at a free end thereof wherein the rod may have the inner cut 32 defined therein horizontally. The gap defined by this cut 32 may be narrow when the pin 30 is inserted into the groove 6. The stopper 31 may act to prevent the fixing pin 30 from escaping from the fixing groove 6.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A window having a rainwater guide device attached thereto,
wherein the widow includes a window frame having a rail portion having a rainwater drainage hole formed in a side face thereof,
wherein the rainwater guide device is coupled to an outer side of the rail portion to be adjacent to the rainwater drainage hole,
wherein the rainwater guide device includes a horizontally elongate bottom plate, and two parallel facing-away longitudinal plates and a single transverse plate, all of the side plates being coupled to the bottom plate,
wherein the rainwater guide device includes a rainwater receiving portion defined at one closed side end thereof to receive the rainwater from the drainage hole and having an open top, and a rainwater outlet defined at the other open side end thereof, through which the rainwater may flow out of the device,
wherein the bottom plate includes a tilted plate tilted downwards from the rainwater receiving portion to the rainwater outlet in a longitudinal direction thereof, and two rainwater guide plates, each guide plate having a first side coupled to the tilted plate and a second side coupled to a corresponding longitudinal side plate, wherein each of the rainwater guide plates is tilted downwardly from the second side to the first side,
wherein the longitudinal side plate facing the window frame has a downward-tilted face defined thereon adjacent to and directly under the drainage hole,
wherein the device has an extended rainwater guide portion protruding perpendicularly to the length direction of the rainwater guide device at the rainwater outlet side,
wherein the device has a plurality of fixing pins protruding from the side face of the side longitudinal plate facing the window frame, wherein the window frame rail portion has a plurality of fixing grooves formed in a side face thereof corresponding to the fixing pins, wherein the fixing pins are pressure-fitted into the fixing grooves respectively,
wherein each of the fixing pins includes as a rod structure having a stopper formed at a free end thereof, wherein the rod structure and/or stopper has an inner cut defined horizontally therein to define a gap, wherein the gap is narrow when the pin is inserted into the groove, and the stopper acts to prevent the fixing pin from escaping from the fixing groove.
